(19) United States
(12) Patent Application Publication
(10) Pub. No.: US 2013/0240389 A1
(43) Pub. Date: Sep. 19, 2013

(54) Connecting Clasp and Multi-Disc Optical Disc Cartridge Using the Connecting Clasp for Connection

(71) Applicant: Chi Yung Wong, Kowloon (HK)

(72) Inventor: Chi Yung Wong, Kowloon (HK)

(73) Assignee: Sunshing Plastic Factory, Huizhou City (CN)

(21) Appl. No.: 13/420,539

(22) Filed: Mar. 14, 2012

(51) Int. Cl. B65D 85/57; E05D 5/02; B65D 85/30

(52) U.S. Cl. 206/308.1; 16/387

(57) ABSTRACT

The present invention discloses a connecting clasp and a multi-disc optical disc cartridge using the connecting clasp for connection. The connecting clasp comprises two half bodies rotationally connecting with each other, wherein one half body can rotate around the other one at a degree from 0° to 180°. The multi-disc optical disc cartridge comprises multiple transparent disc sheets for accommodating optical discs. When the connecting clasp is used for connecting the multiple disc sheets, the two half bodies are inserted into the corresponding mounting sites of the adjacent disc sheets respectively so as to rotationally connect the disc sheets. Therefore, the adjacent disc sheets can rotate relative to each other at a degree from 0° to 180°, or even be displayed in the manner of turning pages at a degree from 0° to 360° when multiple disc sheets are connected together.

### FIELD OF THE INVENTION

The present invention relates to a disc cartridge field, more specifically, to a connecting clasp and a multi-disc optical disc cartridge using the connecting clasp for connection.

### BACKGROUND OF THE INVENTION

Optical discs such as CD and DVD and so on are widely used in daily life. Optical disc cartridges or optical disc bags are widely used in the packing for sales or daily storage of the optical disc product. The existing multi-disc optical disc cartridge is usually divided into a soft bag type and a hard disc type. In the optical disc cartridge of soft bag type, multiple optical disc bags are pasted together and then put into a cloth bag or a plastic bag; while in the optical disc cartridge of hard disc type, a cylinder is provided at the center of the base with its diameter slightly smaller than the inner diameter of the central hole of optical disc. The optical disc can be stacked in the optical disc cartridge by its central hole passing through such cylinder. However, it is not convenient to display and consult the optical discs when they are stored in the above two kinds of optical disc cartridges, thus being inconvenient for usage.

### SUMMARY OF THE INVENTION

Aiming at the above-mentioned defects in the prior art, the objective of the present invention is to provide a connecting clasp and a multi-disc optical disc cartridge using the connecting clasp for connection.

According to an aspect, a connecting clasp for connecting disc sheets is provided in the present invention, comprising two half bodies connecting with each other and rotating relative to each other, wherein, the two half bodies have a same shape of rectangle and have a connecting edge for interconnection extending from the adjacent side thereof respectively; on an opposite surface of each half body is provided a first projection of arc shape.

Specifically, one half body can rotate around the other one at a degree from 0° to 180°.

Specifically, the connecting clasp is made from plastic material formed by an integrated process.

A multi-disc optical disc cartridge is also provided in the present invention, comprising multiple disc sheets for accommodating optical discs, wherein, the disc sheets are in a shape of rectangle and provided with a round plate for placing the optical discs in a form of central depression respectively; hems are formed around at the edges of the disc sheets through their bending downward, wherein one hem is provided with at least four mounting sites of groove shape; the adjacent disc sheets are connected together by the connecting clasp which comprises two half bodies connecting with each other and rotating relative to each other; the two half bodies are inserted into the corresponding mounting sites of the adjacent disc sheets respectively so as to rotationally connect the adjacent disc sheets; multiple disc sheets are connected together in turn to form the multi-disc optical disc cartridge.

Specifically, the mounting site comprises an upper layer and a lower layer, each of which is provided with a mounting hole at its center.

Specifically, the two half bodies of the connecting clasp have a same shape of rectangle and have a connecting edge for rotational connection extending from the adjacent side thereof respectively; wherein one half body can rotate around the other one at a degree from 0° to 180°; one surface of the half body is provided with a first projection of arc shape which is embedded into the mounting hole when the connecting clasp is inserted into the mounting site so as to fix the connecting clasp in the mounting site.

Specifically, the disc sheets can rotate around the disc sheets connected therewith at a degree from 0° to 180°.

Specifically, a first boss of round shape is arranged at the center of the round plate with its diameter a little larger than the inner diameter of the optical disc; a second boss is arranged at the center of the first boss with its diameter equal to the inner diameter of the optical disc; and at least two second projections protruding outward are arranged at the upper edge of the second boss.

Specifically, at least one arc-shaped gap is provided at the edge of the round plate to facilitate the removing of the optical disc.

Specifically, the connecting clasp is made from plastic material formed by an integrated process, and the disc sheet is made from transparent rigid plastic material.

When implementing the present invention, the following advantageous effects can be achieved: the connecting clasp provided in the present invention is simple in structure and can be used in the manner of turning pages when it is used for connecting the disc sheets; in the present invention, the multi-disc optical disc cartridge is formed by connecting the transparent disc sheets together through the connecting clasp, in which case the optical discs accommodated therein can be displayed and consulted conveniently, thus having the advantages of beautiful appearance, lightweight and practicability.

### BRIEF DESCRIPTION OF THE DRAWINGS

The present invention is further described with reference to the accompanying drawings and embodiments in the following. In the figures:

FIG. 1 is a structural diagram for the connecting clasp according to an embodiment of the present invention;

FIG. 2 is a front view for the disc sheet according to an embodiment of the present invention;

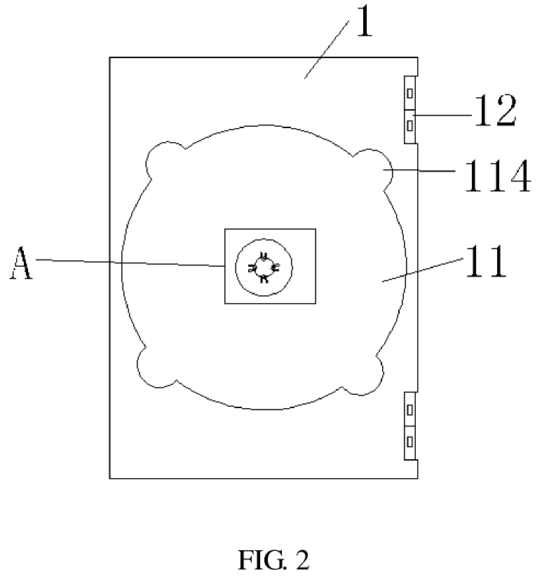

FIG. 3 is a partial enlarged view of the position A in FIG. 1;

FIG. 4 is a stereoscopic perspective view for the disc sheet according to an embodiment of the present invention;

FIG. 5 is a partial enlarged view of the position B in FIG. 3;

FIG. 6 is a schematic diagram for the connection of three disc sheets according to an embodiment of the present invention.

The reference numbers in the accompanying drawings are illustrated as follows:

| | | | |
|---|---|---|---|
| 1 | disc sheet | 2 | connecting clasp |
| 11 | round plate | 12 | mounting site |
| 13 | hem | 21 | half body |
| 22 | first projection | 23 | connecting edge |
| 111 | first boss | 112 | second boss |
| 113 | second projection | 114 | arc-shaped gap |
| 121 | mounting hole | | |

### DETAILED DESCRIPTION OF SPECIFIC EMBODIMENTS

In order to make the technical solutions, objectives and advantages be understood more clearly, the present invention will be illustrated in detail by reference to the accompanying drawings and embodiments in the following. It should be understood that the specific embodiments illustrated herein are only for the purpose of explaining the present invention, not for limiting the present invention.

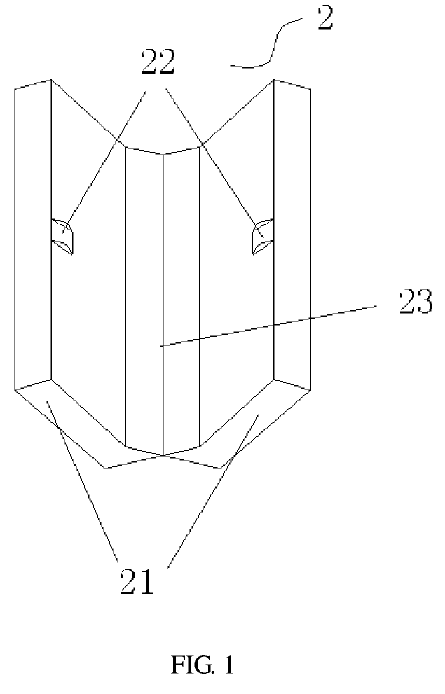

A connecting clasp 2 for connecting disc sheets is provided in the present invention, which can also be used for connecting other things. As illustrated in FIG. 1, the connecting clasp 2 comprises two half bodies 21 connecting with each other and rotating relative to each other. The two half bodies 21 have a same shape of rectangle and have a connecting edge 23 for connecting the two half bodies 21 extending from the adjacent side thereof respectively. Wherein, one half body 21 can rotate around the other one at a degree of 0°-180°. An opposite surface of each half body 21 is provided with a first projection 22 of arc shape. In addition, the connecting clasp 2 is made from plastic material formed by an integrated process. The multiple disc sheets using the connecting clasp 2 for connection can be used in the manner of turning pages at a degree of 360°, thus being very beautiful and convenient.

A multi-disc optical disc cartridge is also provided in the present invention, which comprises multiple disc sheets 1 for accommodating optical discs. In the present embodiment, the accommodated optical discs are ordinary optical discs with an outer diameter of 120 mm and an inner diameter of 15 mm. It is obvious that the size of the disc sheet 1 may be adjusted according to the accommodated optical disc. All of the disc sheets 1 have the same shape. As illustrated in FIG. 1, the shape for the main body of the disc sheet 1 is rectangle. A round plate 11 in the form of central depression is provided at the center of the disc sheet with its outer diameter a little larger than that of the optical disc respectively. In order to facilitate the removing of the optical disc, at least one arc-shaped gap 114 is provided at the edge of the round plate 11. In the present embodiment, four arc-shaped gaps 114 are provided, the center points of which are connected in turn to form a square taking the circle center of the round plate as its center point.

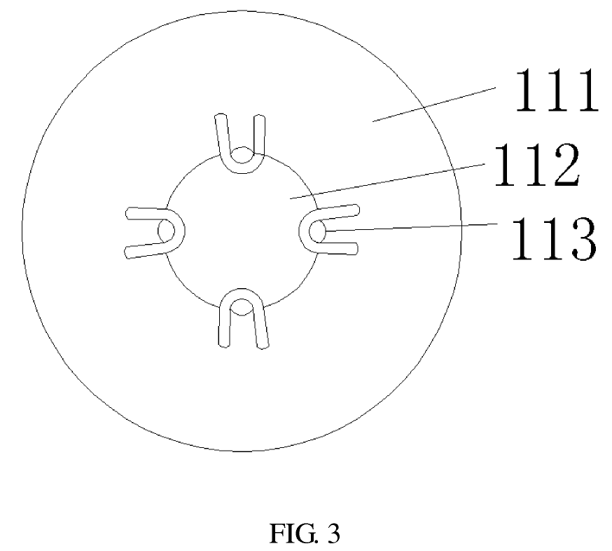

As illustrated in FIG. 3, a first boss 111 is embossed from the center of the round plate 11 with its diameter a little larger than the inner diameter of the optical disc and with its height to be about 1-2 mm. Furthermore, a second boss 112 is embossed from the center of the first boss 111 with its diameter equal to the inner diameter of the optical disc. The sum of the heights of the first boss 111 and the second boss 112 is smaller than or equal to the depth of the round plate 11. In the present embodiment, the two are set to be equal. Besides, at least two second projections 113 protruding outward are arranged at the upper edge of the first boss 111. In the present embodiment, there are four such projections 113. When the optical disc is put in the disc sheet 1, the optical disc is hold up at the center by the first boss 111, so that the part recording information hangs in the air and loses contact with the bottom of the round plate 11 to avoid abrasion. As the diameter of the second boss 112 is equal to the inner diameter of the optical disc, the optical disc placed thereon is stable without wobbling. Besides, the disc placed in the disc sheet can get stuck by the second projection 113 without coming off easily.

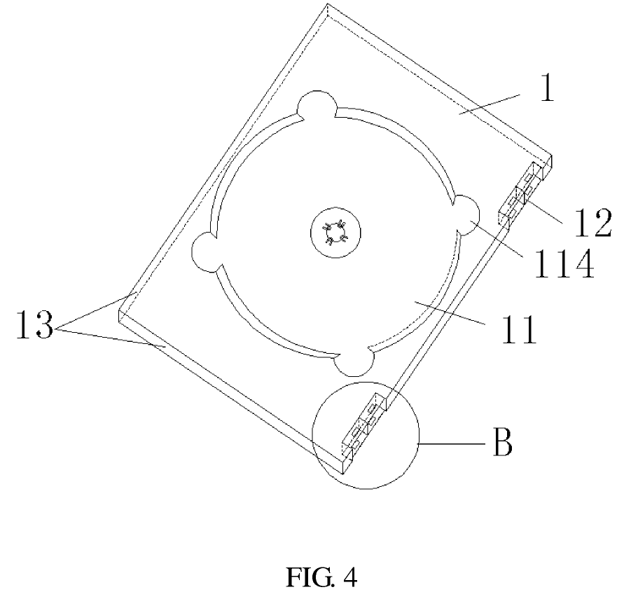

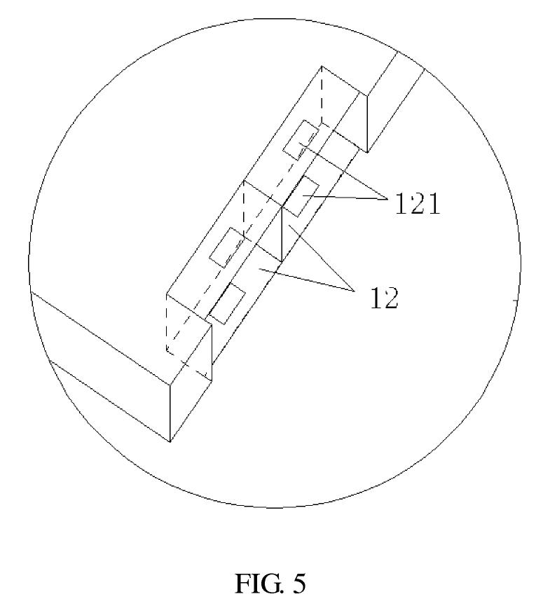

As illustrated in FIG. 4, the edges of the disc sheet 1 bend downward to form hems 13 around that are perpendicular to the main body of the disc sheet. The height of the hem 13 is equal to the depth of the depression of the round plate 11. Wherein, four mounting sites 12 are arranged on one hem, with two on the upper part and the other two on the lower part. As illustrated in FIG. 5, the mounting site 12 is a square groove divided into an upper layer and a lower layer, each of which is provided with a mounting hole 121 at the center with the location corresponding to each other.

The connecting clasp 2 is utilized to connect the disc sheets 1. As illustrated in FIG. 1, each connecting clasp 2 consists of two half bodies 21 connecting with each other. The two half bodies 21 have the same shape of rectangle and have a connecting edge 23 for rotational connection extending from the adjacent side thereof respectively. Wherein, one half body 21 can rotate around the other one at a degree from 0° to 180°. Each half body 21 is provided with a first projection 22 of arc shape at its center in the outer part. When the two disc sheets 1 are connected together, the two half bodies 21 of the connecting clasps 2 are inserted into the mounting sites 12 respectively, and the first projections 22 are then embedded into the mounting holes 121. In this way, the connecting clasp 2 is prevented from coming off easily and the stability of the connection between the disc sheets 1 is guaranteed. To keep balance, when the two disc sheets 1 are connected, at least two connecting clasps 2 are required which are inserted into the corresponding mounting sites 12 arranged on the upper end and the lower end of the disc sheet 1 respectively.

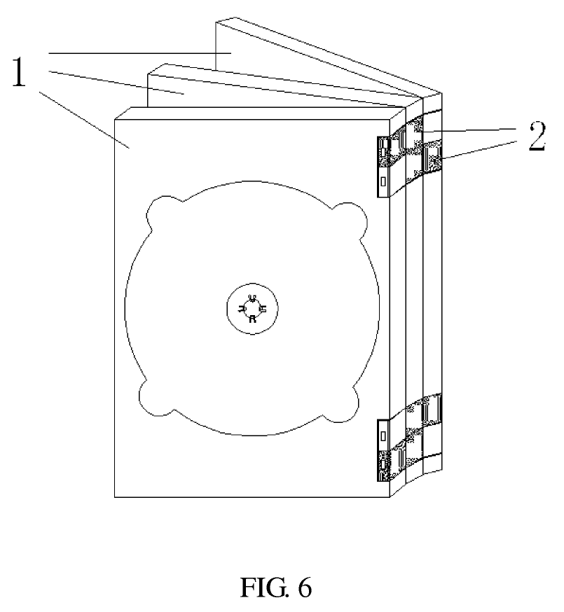

Taking the triple-piece disc sheets 1 illustrated in FIG. 6 as an example, when more than two disc sheets 1 are connected together to form a multi-disc optical disc cartridge, the outmost two disc sheets 1 are just connected with one disc sheet 1 adjacent thereto respectively; while the disc sheet 1 located between the outmost two disc sheets 1 is needed to be connected with the two disc sheets 1 adjacent thereto, so four connecting clasps and four mounting sites are required to be connected with the two disc sheets 1 adjacent thereto respectively. Of course, more mounting sites, such as six mounting sites, can be provided to further improve the stability of the connection. Each connected disc sheet 1 may rotate around the disc sheet connected therewith at a degree from 0° to 180°. When multiple disc sheets 1 are connected together to form a multi-disc optical disc cartridge, the multiple discs may be rotated and be placed at a degree from 0° to 360°, which may also be used in the manner of turning pages at a degree of 360°. In addition, the disc sheets of the present embodiment are all made from transparent plastic material. Moreover, it is very convenient to display and consult the optical discs inside the optical disc cartridge.

It is should understood that the connecting clasp 2 provided in the present invention can not only used in the connection of the multiple optical disc cartridge, but also used for connecting other things such as a turn-page-type calendar and so on.

What is claimed is:

1. A connecting clasp (2) for connecting disc sheets, comprising two half bodies (21) connecting with each other and rotating relative to each other; the two half bodies (21) have a same shape of a rectangle and have a connecting edge (23) for interconnection extending from an adjacent side thereof respectively; on an opposite surface of each half body (21) is provided a first projection (22) of an arc shape.

2. The connecting clasp of claim 1, wherein one half body (21) can rotate around the other one at a degree from 0° to 180°.

3. The connecting clasp of claim 1, wherein the connecting clasp (2) is made from a plastic material formed by an integrated process.

4. A multi-disc optical disc cartridge, comprising
multiple disc sheets (1) for accommodating optical discs, wherein the disc sheets (1) are in a shape of a rectangle and provided with a round plate (11) for placing optical discs in a form of a central depression;
one or more hems (13) are formed around at the edges of the disc sheets (11) through their bending downward, wherein one hem (13) is provided with at least four mounting sites (12) of a groove shape;
adjacent disc sheets (1) are connected together by a connecting clasp (2) which comprises two half bodies (21) connecting with each other and rotating relative to each other;
the two half bodies (21) are inserted into corresponding mounting sites (12) of the adjacent disc sheets respectively so as to rotationally connect the adjacent disc sheets (1);
multiple disc sheets (1) are connected together in turn to form the multi-disc optical disc cartridge.

5. The multi-disc optical disc cartridge of claim 4, wherein each mounting site (12) comprises an upper layer and a lower layer, each of which is provided with a mounting hole (121) at its center.

6. The multi-disc optical disc cartridge of claim 5, wherein the two half bodies (21) of the connecting clasp (2) have a same shape of a rectangle and have a connecting edge (23) for rotational connection extending from an adjacent side thereof respectively; wherein one half body (21) can rotate around the other one at a degree from 0° to 180°; one surface of a half body (21) is provided with a first projection (22) of an arc shape, which is embedded into the mounting hole (121) when the connecting clasp is inserted into the mounting site so as to fix the connecting clasp (2) in the mounting site (12).

7. The multi-disc optical disc cartridge of claim 4, wherein the disc sheets (1) can rotate around the disc sheets connected therewith at a degree from 0° to 180°.

8. The multi-disc optical disc cartridge of claim 4, wherein a first boss (111) of a round shape is arranged at a center of the round plate (11) with its diameter a little larger than an inner diameter of the optical disc; a second boss (112) is arranged at a center of the first boss (111) with its diameter equal to an inner diameter of the optical disc; and at least two second projections (113) protruding outward are arranged at an upper edge of the second boss (112).

9. The multi-disc optical disc cartridge of claim 4, wherein at least one arc-shaped gap (114) is provided at an edge of the round plate (11) to facilitate the removing of the optical disc.

10. The multi-disc optical disc cartridge of claim 4, wherein the connecting clasp (2) is made from a plastic material formed by an integrated forming, and the disc sheet (1) is made from a transparent rigid plastic material.
